(19) United States
(12) Patent Application Publication
(10) Pub. No.: US 2006/0231321 A1
(43) Pub. Date: Oct. 19, 2006

(54) Collision obstacle discrimination device for vehicle

(75) Inventor: Hisashi Takahashi, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/402,313

(22) Filed: Apr. 11, 2006

(30) Foreign Application Priority Data
Apr. 13, 2005 (JP) 2005-116296

(51) Int. Cl. B60K 28/10; B60Q 1/00

(52) U.S. Cl. 180/274; 340/436

(57) ABSTRACT

A collision obstacle discrimination device for a vehicle has a detection unit arranged between a bumper and side members of the vehicle, and a discrimination unit. The detection unit detects collision energy applied to the bumper at at least an upper position and a lower position thereof, to respectively output at least an upper detection signal and a lower detection signal when an obstacle collides with the bumper. The discrimination unit sort-discriminates the obstacle by comparing the upper detection signal and the lower detection signal.

### CROSS REFERENCE TO RELATED APPLICATION

This application is based on a Japanese Patent Application No. 2005-116296 filed on Apr. 13, 2005, the disclosure of which is incorporated herein by reference.

### FIELD OF THE INVENTION

The present invention relates to a collision obstacle discrimination device for actuating a protection device, for example, a pedestrian-protecting airbag and the like.

### BACKGROUND OF THE INVENTION

Recently, a pedestrian-protecting airbag system for a vehicle is developed to protect a pedestrian. When the vehicle collides with the pedestrian, the pedestrian-protecting airbag system provides an airbag which is deployed on a bonnet of the vehicle to prevent a head portion and a breast portion of the pedestrian from colliding with the bonnet or a windshield of the vehicle.

Thus, a collision obstacle discrimination device becomes necessary for an actuation of the pedestrian-protecting airbag system. That is, it is necessary for the collision obstacle discrimination device to discriminate between a pedestrian who is to be protected by the deployed airbag and other objects which are unnecessarily protected. In the case where the pedestrian-protecting airbag is unnecessarily deployed, an extra repair cost is to be spent. Moreover, the collision obstacle discrimination device is required to have a quick response performance, because the pedestrian-protecting airbag is to be deployed earlier than the violent collision of the pedestrian with the vehicle.

Referring to U.S. Pat. No. 6,784,792-B2 (JP-2003-535769A), for example, each of the bonnet and a bumper of the vehicle is provided with a collision detection sensor to judge whether or not the obstacle is a pedestrian based on outputs of the sensors.

In this case, the single sensor is attached to the bonnet so that the collision obstacle cannot be sort-distinguished until colliding with the bonnet. That is, the response performance of the discrimination device referring to U.S. Pat. No. 6,784,792-B2 is inferior. Thus, when the obstacle is a pedestrian, it is difficult to deploy the pedestrian-protecting airbag to protect the pedestrian before the pedestrian violently collides with the bonnet.

### SUMMARY OF THE INVENTION

In view of the above-described disadvantages, it is an object of the present invention to provide a collision obstacle discrimination device for a vehicle to sort-distinguish an obstacle, so that a deploy instruction can be output to a pedestrian-protecting airbag or the like before a violent collision between the obstacle and a bonnet of the vehicle in the case where the obstacle is a pedestrian.

According to an aspect of the present invention, a collision obstacle discrimination device for a vehicle is provided with a detection unit which is arranged between a bumper and side members of the vehicle, and a discrimination unit. The detection unit detects collision energy applied to the bumper at at least an upper position and a lower position thereof, to respectively output at least an upper detection signal corresponding to the upper position and a lower detection signal corresponding to the lower position, when an obstacle collides with the bumper. The discrimination unit sort-discriminates the obstacle based on the upper detection signal and the lower detection signal.

Thus, the obstacle can be distinguished between the one fixed on the ground and the one non-fixed on the ground. In this case, the collision energy which indicates the collision intensity can be calculated based on a collision load applied to the vehicle, a vehicle acceleration or the like.

Preferably, the discrimination unit sort-discriminates the obstacle by comparing the upper detection signal with the lower detection signal.

Therefore, the obstacle can be sort-discriminated via a simple algorithm.

More Preferably, the detection unit is arranged between an absorber of the vehicle and a reinforcement member of the vehicle.

Because the reinforcement member is made of a material having a high stiffness, the detection accuracy of the collision energy can be improved.

More Preferably, the detection unit is arranged between a reinforcement member of the vehicle and the side members.

Because each of the reinforcement member and the side member is made of a material having a high stiffness, the collision energy can be detected without being leaked.

### BRIEF DESCRIPTION OF THE DRAWINGS

Other objects, features and advantages of the present invention will become more apparent from the following detailed description made with reference to the accompanying drawings, in which:

FIG. 1A is a schematic plan view showing a collision obstacle discrimination device for a vehicle according to a first embodiment of the present invention, and FIG. 1B is a schematic side view of the collision obstacle discrimination device;

FIG. 2 is a partial perspective view showing the collision obstacle discrimination device which is mounted in the vehicle according to the first embodiment;

FIG. 3 is a block diagram showing an input and an output in the collision obstacle discrimination device according to the first embodiment;

FIG. 4A is a schematic view showing a collision at the time t0 between the collision obstacle discrimination device and an obstacle fixed on the ground according to the first embodiment, and FIG. 4B is a schematic view showing the collision at the time t1;

FIG. 5 is a graph showing time-series outputs of an upper optical fiber sensor and a lower optical fiber sensor in the case where the collision obstacle discrimination device collides with the obstacle fixed on the ground according to the first embodiment;

FIG. 6A is a schematic view showing a collision at the time t0 between the collision obstacle discrimination device and an obstacle non-fixed on the ground according to the first embodiment, and FIG. 6B is a schematic view showing the collision at the time t2;

FIG. 7 is a graph showing time-series outputs of the upper optical fiber sensor and the lower optical fiber sensor in the case where the collision obstacle discrimination device collides with the obstacle non-fixed on the ground according to the first embodiment;

FIG. 8 is a flow chart showing a discrimination process of a discrimination unit according to the first embodiment;

FIG. 9 is a flow chart showing a discrimination process of a discrimination unit according to a second embodiment of the present invention;

FIG. 10 is a schematic side view of a collision obstacle discrimination device for a vehicle according to a third embodiment of the present invention;

FIG. 11A is a schematic view showing an average collision load FA and a moment M applied to the collision obstacle discrimination device in the case where an obstacle collides with the collision obstacle discrimination device in a vehicle traveling direction according to the third embodiment, and FIG. 11B is a schematic view showing components F1 and F2 of the average collision load FA;

FIG. 12A is a schematic view showing a collision at the time t0 between the collision obstacle discrimination device and an obstacle fixed on the ground according to the third embodiment, and FIG. 12B is a schematic view showing the collision at the time t1;

FIG. 13 is a graph showing time-series outputs of the average load FA and the moment M detected by a stress sensor in the case where the collision obstacle discrimination device collides with the obstacle fixed on the ground according to the third embodiment;

FIG. 14A is a schematic view showing a collision at the time t0 between the collision obstacle discrimination device and an obstacle non-fixed on the ground according to the third embodiment, and FIG. 14B is a schematic view showing the collision at the time t2;

FIG. 15 is a graph showing time-series outputs of the average load FA and the moment M detected by the stress sensor in the case where the collision obstacle discrimination device collides with the obstacle non-fixed on the ground according to the third embodiment;

FIG. 16 is a flow chart showing a discrimination process of a discrimination unit according to the third embodiment;

FIG. 17A is a schematic plan view showing a collision obstacle discrimination device for a vehicle according to a fourth embodiment of the present invention, and FIG. 17B is a schematic side view of the collision obstacle discrimination device;

FIG. 18 is a partial perspective view showing the collision obstacle discrimination device which is mounted in the vehicle according to the fourth embodiment;

FIG. 19 is a flow chart showing a discrimination process of a discrimination unit according to the fourth embodiment;

FIG. 20 is a partial perspective view showing a collision obstacle discrimination device for a vehicle according to a fifth embodiment of the present invention;

FIG. 21 is a schematic view showing a crank-typed sensor according to the fifth embodiment;

FIG. 22 is a schematic view showing the crank-typed sensor to which a force is applied according to the fifth embodiment;

FIG. 23A is a graph showing a sum of time-series outputs of the left crank-typed sensor and the right crank-typed sensor in the case where the collision obstacle discrimination device collides with a pedestrian according to the fifth embodiment, FIG. 23B is a graph showing a time-series output of an upper touch sensor in this case, and FIG. 23C is a graph showing a time-series output of a lower touch sensor in this case;

FIG. 24 is a flow chart showing a discrimination process of a discrimination unit according to the fifth embodiment; and

FIG. 25 is a block diagram showing an input and an output in a collision obstacle discrimination device according to a sixth embodiment of the present invention.

### DETAILED DESCRIPTION OF THE PREFERRED EMBODIMENTS

(First Embodiment)

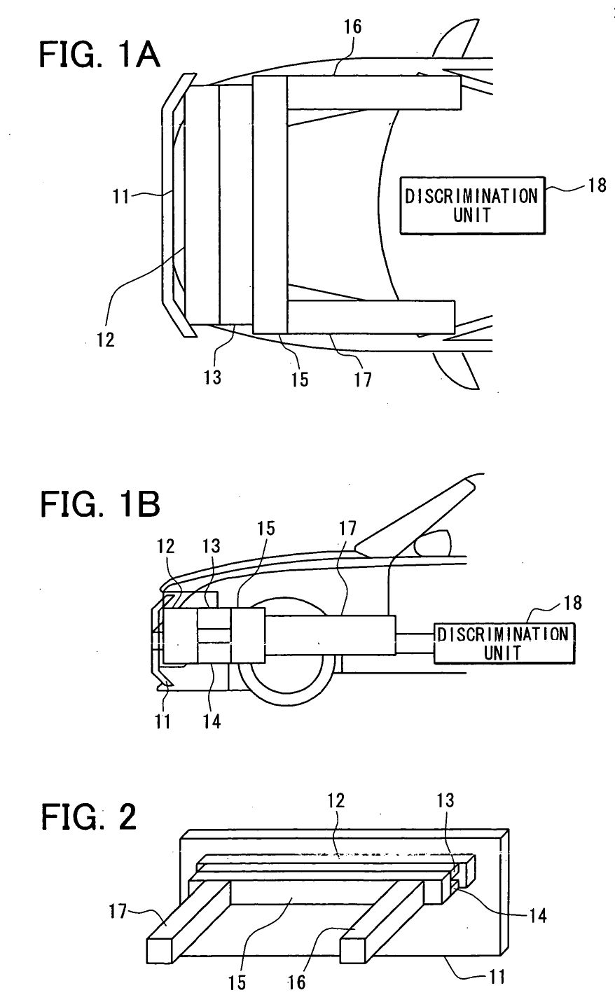

A collision obstacle discrimination device for a vehicle according to a first embodiment of the present invention will be described with reference to FIGS. 1-8.

As shown in FIG. 1A, a front bumper 11 of the vehicle is arranged at a front surface (with respect to vehicle traveling direction) of an absorber 12 of the vehicle, and extends in the vehicle width direction (perpendicular to vehicle traveling direction). In the case where an obstacle collides with the front bumper 11, the front bumper 11 can be deformed so that the impact on the obstacle is buffered by the absorber 12.

The absorber 12 is fixed to a reinforcement member 15 of the vehicle through a detection unit, which is constructed of an upper optical fiber sensor 13 (upper sensor) and a lower optical fiber sensor 14 (lower sensor). A right side member 16 and a left side member 17 of the vehicle are respectively connected with a right end portion and a left end portion of the reinforcement member 15.

The upper optical fiber sensor 13 and the lower optical fiber sensor 14 are mounted between a front surface of the reinforcement member 15 and a rear surface of the absorber 12. The upper optical fiber sensor 13 is positioned at the upper side of the lower optical fiber sensor 14. That is, the upper optical fiber sensor 13 is arranged at an upper position, which is disposed at the upper side of a lower position where the lower optical fiber sensor 14 is disposed.

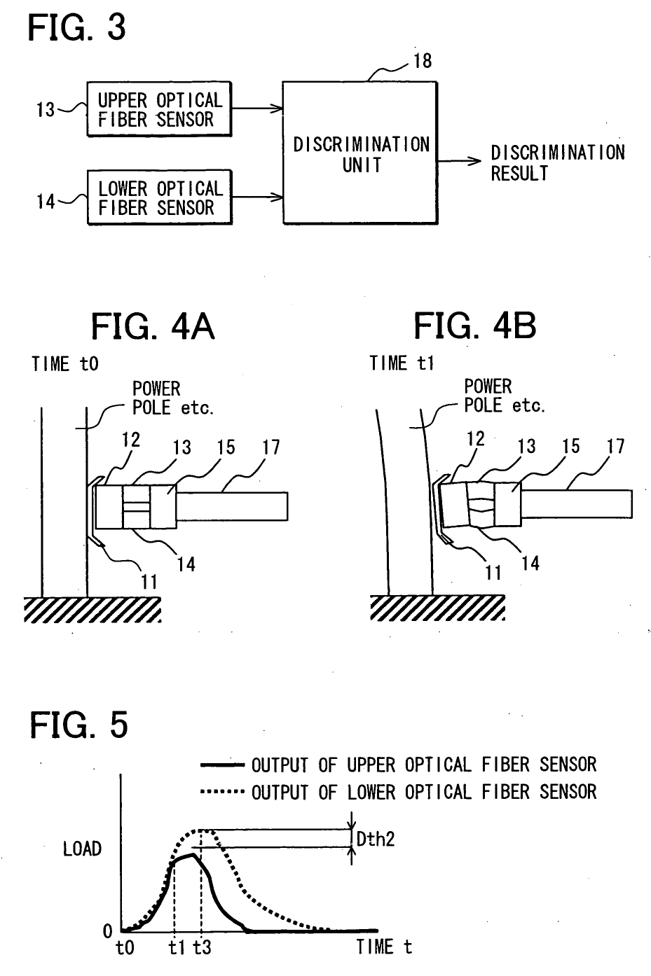

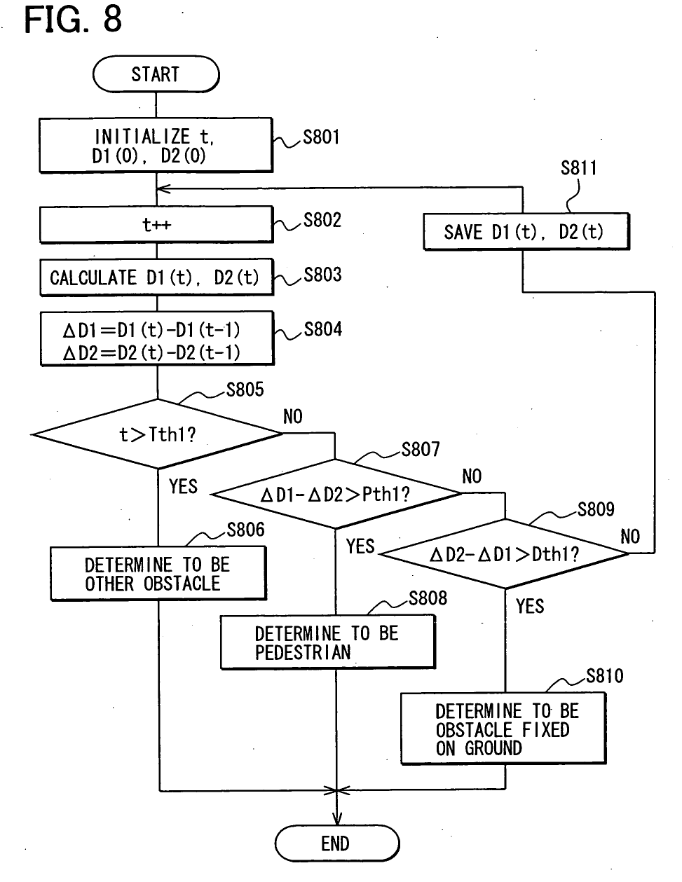

Referring to FIG. 3, output (upper detection signal) from the upper optical fiber sensor 13 and output (lower detection signal) from the lower optical fiber sensor 14 are sent to a discrimination unit 18, which sort-discriminates an obstacle colliding with the vehicle (e.g., bumper 11 thereof) based on an operation process shown in FIG. 8. Thus, a collision energy which is applied to the vehicle due to the obstacle collision can be detected by calculating, for example, a collision load (exerted to vehicle) detected by the optical fiber sensors 13 and 14.

Referring to FIGS. 4A-7, the outputs of the optical fiber sensors 13 and 14 will vary responding to the sort of the obstacle.

In the case where the vehicle collides with the obstacle (e.g., power pole) fixed on the ground, as shown in FIG. 4A, the front bumper 11 initially substantially horizontally contacts the obstacle at the beginning (set as time t0) of the collision between the obstacle and the vehicle. Thereafter, as shown in FIG. 4B, with the development of the collision (e.g., at time t1 which is described later), the upper optical fiber sensor 13 and the lower optical fiber sensor 14 are distorted (deformed). In this case, the distortion of the upper optical fiber sensor 13 is less than that of the lower optical fiber sensor 14, because the lower end portion of the obstacle is fixed on the ground to have a larger stiffness than the upper portion thereof.

FIG. 5 shows the time-series outputs (i.e., detection load) of the upper optical sensor 13 and the lower optical sensor 14 after the collision occurrence in the case where the vehicle collides with the obstacle fixed on the ground. In FIG. 5, the loads detected by the upper optical sensor 13 and the lower optical sensor 14 are respectively indicated by a solid line and a broken line. The instant of the collision between the obstacle with the vehicle is set as the time t0.

Referring to FIG. 5, there is not a noteworthy difference between the outputs of the upper optical fiber sensor 13 and the lower optical fiber sensor 14 during the period (from time t0 to time t1) immediately after the collision occurs. In this case, the obstacle is fixed on the ground so that the obstacle and the front bumper 11 will incline with a fulcrum of the ground after the time t1 due to the collision. Therefore, after the time t1, the increase speed of the load applied to the lower optical fiber senor 14 becomes greatly larger than that of the load applied to the upper optical fiber sensor 13.

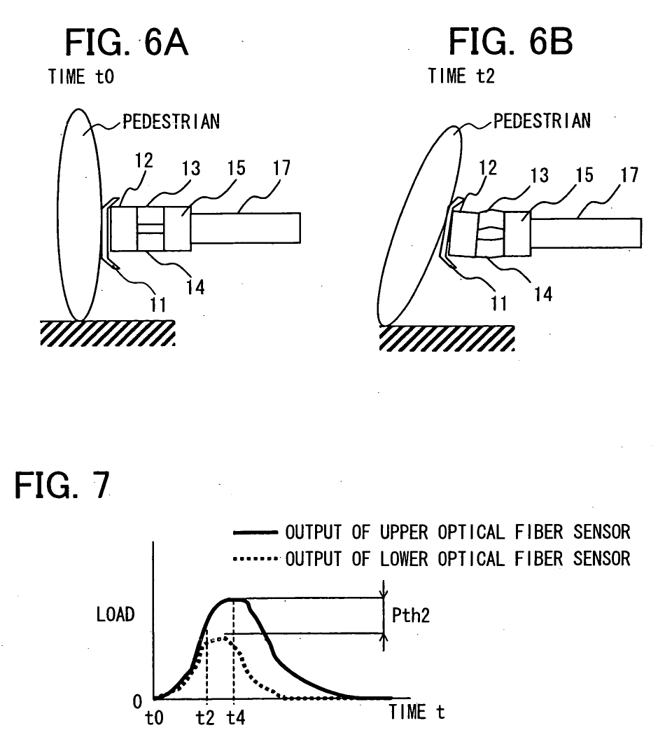

In the case where the vehicle collides with the obstacle (e.g., human such as pedestrian) non-fixed on the ground, as shown in FIG. 6A, the front bumper 11 initially substantially horizontally contacts the obstacle at the beginning (set as time t0) of the collision between the obstacle and the vehicle. That is similar to the case of the obstacle fixed on the ground. With the progress of the collision (e.g., at time t2 which is described later), the obstacle which is not fixed on the ground falls toward a bonnet of the vehicle. As a result, as shown in FIG. 6B, the distortion of the upper optical fiber sensor 13 is more than that of the lower optical fiber sensor 14.

FIG. 7 shows the time-series outputs (i.e., detection load) of the upper optical sensor 13 and the lower optical sensor 14 after the collision occurrence in the case where the vehicle collides with the obstacle non-fixed on the ground. In FIG. 7, the loads detected by the upper optical sensor 13 and the lower optical sensor 14 are respectively indicated by a solid line and a broken line. The instant of the collision between the obstacle and the vehicle is set as the time t0.

Referring to FIG. 7, there is not a noteworthy difference between the outputs of the upper optical fiber sensor 13 and the lower optical fiber sensor 14 during the period (from time t0 to time t2) immediately after the collision occurs. That is, the load applied to the upper optical fiber sensor 13 is substantially equal to that applied to the lower optical fiber sensor 14 in both the case of the obstacle (e.g., power pole) fixed on the ground and the case of the obstacle (e.g., pedestrian) non-fixed on the ground.

However, referring to FIG. 7, because the non-fixed obstacle (e.g., pedestrian) inclines to the side of the bonnet of the vehicle after the time t2, the increase speed of the load applied to the upper optical fiber senor 13 becomes greatly larger than that applied to the lower optical fiber sensor 14.

Therefore, in the case of the obstacle fixed on the ground, the increase speed of the output of the upper optical fiber sensor 13 is smaller than that of the lower optical fiber sensor 14 after the collision occurrence (i.e., after time t1). On the other hand, in the case of the obstacle (e.g., pedestrian) non-fixed on the ground, the increase speed of the output of the lower optical fiber sensor 14 is smaller than that of the upper optical fiber sensor 13 after the collision occurrence (i.e., after time t2). Thus, according to this characteristic, the discrimination unit 18 can sort-discriminate the obstacle which collides with the vehicle.

The discrimination operation performed by the discrimination unit 18 will be described with reference to FIG. 8. The discrimination operation is started at the time when the collision between the vehicle and the obstacle occurs. At first, at step S801, a time counter t, an output value D1(t) of the upper optical fiber sensor 13 and an output value D2(t) of the lower optical fiber sensor 14 are initialized, that is, t=D1(0)=D2(0)=0.

Then, at step S802, “1” is added to the time counter t. At step S803, the output value D1(t) of the upper optical fiber sensor 13 and the output values D2(t) of the lower optical fiber sensor 14 are calculated. Thereafter, at step 804, the preceding output value D1(t−1) is subtracted form the output value D1(t) to calculate a time-series variation amount ΔD1 (that is, increase speed), and the preceding output value D2(t−1) is subtracted form the output value D2(t) to calculate a time-series variation amount ΔD2.

Then, at step S805, it is judged whether or not the time counter t is larger than a discrimination upper limit time Tth1. In the case where the time counter t is larger than Tth1, it is considered that the human (e.g., pedestrian) and the object fixed on the ground cannot be distinguished by performing the process during the period with the discrimination upper limit time Tth1, and then it is determined at step S806 that the obstacle is an object (e.g., rubbish box, shopping cart and the like which are not fixed on the ground) other than the pedestrian and the object fixed on the ground. Moreover, at step S806, the discrimination result that the obstacle is the object other than the pedestrian and the object fixed on the ground is output.

On the other hand, in the case where it is determined at step S805 that the time counter t is smaller than or equal to the discrimination upper limit time Tth1, step S807 will be performed. At step S807, it is further judged whether or not the difference (i.e., ΔD1−ΔD2) between the time-series variation amount ΔD1 of the upper optical fiber sensor 13 and the time-series variation amount ΔD2 of the lower optical fiber sensor 14 is larger than a threshold value Pth1. In the case where it is determined that the difference between the time-series variation amount ΔD1 and the time-series variation amount ΔD2 is larger than the threshold value Pth1 (that is, increase speed of load exerted to upper optical fiber sensor 13 is larger than that applied to lower optical fiber sensor 14 as shown after time t2 of FIG. 7), step S808 will be performed. At step S808, the discrimination result that the obstacle is the pedestrian is output.

On the contrary, in the case where it is determined that the difference between the time-series variation amount ΔD1 and the time-series variation amount ΔD2 is smaller than or equal to the threshold value Pth1, step S809 will be performed.

At step S809, it is judged whether or not the difference (i.e., ΔD2−ΔD1) between the time-series variation amount ΔD2 and the time-series variation amount ΔD1 is larger than a threshold value Dth1. In the case where it is determined that the difference (i.e., ΔD2−ΔD1) between the time-series variation amount ΔD2 and the time-series variation amount ΔD1 is larger than the threshold value Dth1 (that is, increase speed of load exerted to lower optical fiber sensor 14 is larger than that of load exerted to upper optical fiber sensor 13 as shown after time t1 of FIG. 5), step S810 will be performed. At step S810, the discrimination result that the obstacle is fixed on the ground is output.

On the contrary, in the case where it is determined that the difference (i.e., ΔD2−ΔD1) between the time-series variation amount ΔD2 and the time-series variation amount ΔD1 is smaller than or equal to the threshold value Dth1, the output value D1(t) of the upper optical fiber sensor 13 and the output values D2(t) of the lower optical fiber sensor 14 are saved at step S811, and then the operation will return to step S802 to be performed from step S802 again.

In the case where the discrimination result has been output at one of steps S806, S808 and S810, the discrimination operation shown in FIG. 8 will be ended.

According to the collision obstacle discrimination device described in the first embodiment, it can be distinguished whether or not the obstacle is the human. (e.g., pedestrian). The discrimination unit 18 can output the discrimination result before the pedestrian violently collides with the bonnet of the vehicle or the like, so that a pedestrian-protecting airbag or the like can be actuated to protect the pedestrian.

In this case, the time-series variation amount (ΔD1, ΔD2), that is, a differentiation value with respect to the time is used as the obstacle sort-discrimination condition. Therefore, as compared with the case (described later in second embodiment) where a difference at a time between the output value of the upper optical fiber sensor 13 and that of the lower optical fiber sensor 14 is used as the obstacle sort-discrimination condition, the obstacle can be more substantially sort-distinguished according to the first embodiment even when the difference between the signal detected by the upper optical fiber sensor 13 and that detected by the lower optical fiber sensor 14 is greatly small (for example, collision obstacle is child who is not fixed on the ground and has barycenter little higher than bumper 11).

(Second Embodiment)

According to a second embodiment of the present invention, the difference at a time between the output value of the upper optical fiber sensor 13 and that of the lower optical fiber sensor 14 is used as the discrimination condition for sort-discriminating the obstacle.

Referring to FIGS. 4A-7, in the case of the obstacle fixed on the ground, the difference between the output value of the lower optical fiber sensor 14 and that of the upper optical fiber sensor 13 becomes larger than Dth2 (threshold value) at the time t3 which is larger than the time t1. On the other hand, in the case of the obstacle (e.g., pedestrian) non-fixed on the ground, the difference between the output value of the upper optical fiber sensor 13 and that of the lower optical fiber sensor 14 becomes larger than Pth2 (threshold value) at the time t4 which is larger than the time t2. Thus, according to this characteristic, the discrimination unit 18 can sort-discriminate the obstacle.

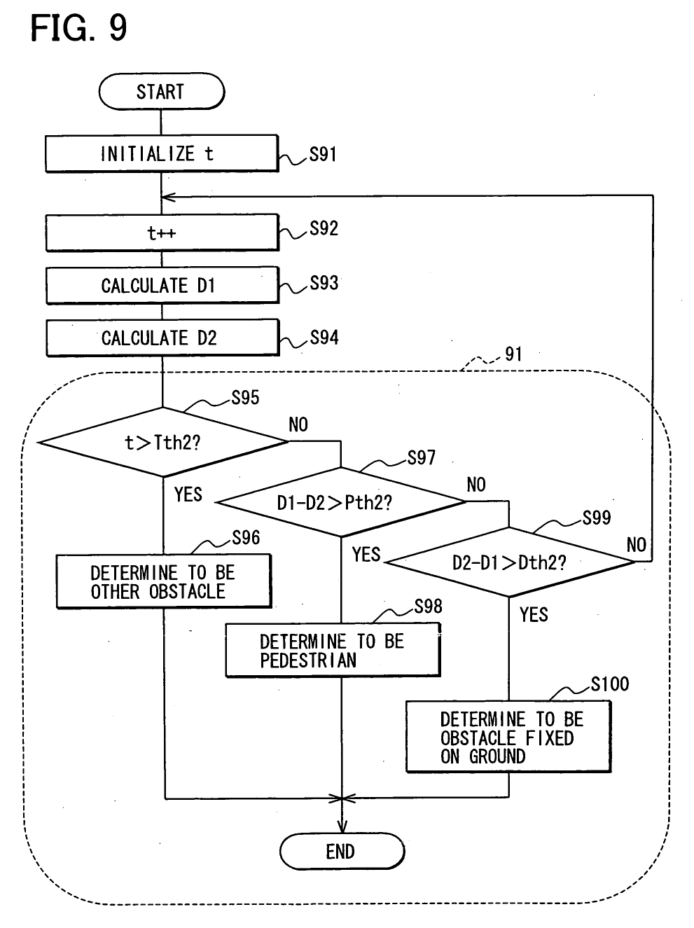

The discrimination operation performed by the discrimination unit 18 according to the second embodiment will be described with reference to FIG. 9. This operation is started at the time when the collision between the vehicle and the obstacle occurs. At first, at step S91, the time counter t is initialized, that is, t=0. Then, at step S92, “1” is added to the time counter t. Thereafter, the output value D1 of the upper optical fiber sensor 13 is calculated at step S93, and the output value D2 of the lower optical fiber sensor 14 is calculated at step S94.

Subsequently, at step S95, it is judged whether or not the time counter t is larger than a discrimination upper limit time Tth2. In the case where the time counter t is larger than Tth2, it is considered that the human (e.g., pedestrian) and the object fixed on the ground cannot be distinguished by performing the process during the period with the discrimination upper limit time Tth2, and then it is determined at step S96 that the obstacle is an object (e.g., rubbish box, shopping cart and the like which are not fixed on the ground) other than the pedestrian and the object fixed on the ground. Moreover, at step S96, the discrimination result that the obstacle is the object other than the pedestrian and the object fixed on the ground is output.

On the other hand, in the case where it is determined at step S95 that the time counter t is smaller than or equal to the discrimination upper limit time Tth2, step S97 will be performed. At step S97, it is further judged whether or not the difference (i.e., D1−D2) between the output value D1 of the upper optical fiber sensor 13 and the output value D2 of the lower optical fiber sensor 14 is larger than the threshold value Pth2. In the case where it is determined that the difference between the output value D1 and the output value D2 is larger than the threshold value Pth2 (that is, difference between load exerted to upper optical fiber sensor 13 and that exerted to lower optical fiber sensor 14 is larger than threshold value Pth2 as shown at time t4 of FIG. 7), step S98 will be performed. At step S98, the discrimination result that the obstacle is the pedestrian is output.

On the contrary, in the case where it is determined that the difference between the output value D1 and the output value D2 is smaller than or equal to the threshold value Pth2, step S99 will be performed.

At step S99, it is judged whether or not the difference (i.e., D2−D1) between the output value D2 and the output value D1 is larger than the threshold value Dth2. In the case where it is determined that the difference between the output value D2 and the output value D1 is larger than the threshold value Dth2 (that is, difference between load exerted to lower optical fiber sensor 14 and that exerted to upper optical fiber sensor 13 is larger than Dth2 as shown at time t3 of FIG. 5), step S100 will be performed. At step S100, the discrimination result that the obstacle is fixed on the ground is output.

On the contrary, in the case where it is determined that the difference between the output value D2 and the output value D1 is smaller than or equal to the threshold value Dth2, the operation will return to step S92 and be performed from step S92 again.

In the case where the discrimination result has been output at one of steps S96, S98 and S100, the operation shown in FIG. 9 will be ended.

According to the second embodiment, the collision obstacle discrimination device sort-discriminates the obstacle by using the detection signals at the same time of the upper optical fiber sensor 13 and the lower optical fiber sensor 14. Therefore, the obstacle can be substantially sort-discriminated without being influenced by noise or the like, for example, in the case where the upper optical fiber sensor 13 or/and the lower optical fiber sensor 14 vibrates to cause noise in the detection signals of the upper optical fiber sensor 13 and the lower optical fiber sensor 14.

(Third Embodiment)

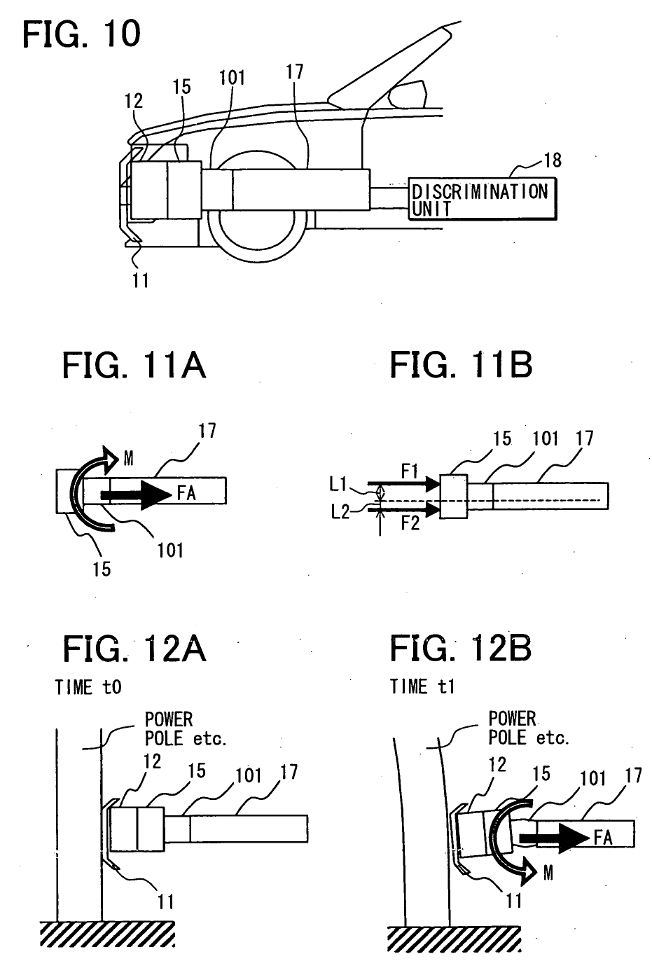

According to a third embodiment of the present invention, referring to FIG. 10, the detection unit is constructed of a stress sensor 101 (bearing sensor) instead of the upper optical fiber sensor 13 and the lower optical fiber sensor 14 in the above-described first embodiment. The stress sensor 101 is arranged between the reinforcement member 15 and the side members 16, 17,

The output of the stress sensor 101 includes a coordinate value (x, y) of a detection position ranging in the stress sensor 101, and a load value F(x, y) which is applied to the stress sensor 101 at the detection position with the coordinate value (x, y). The average of the load values of all the detection positions detected by the stress sensor 101 is expressed as FA, referring to FIG. 11A.

As shown in FIGS. 11A and 11B, in the case where the collision occurs in the vehicle traveling direction, the average load FA applied to the stress sensor 101 from the vehicle front side can be decomposed into two front-rear-direction (of vehicle) components F1 and F2 along the substantial up-down direction of the side member 16, 17 (stress sensor 101). That is, the load components F1 and F2 are respectively applied to the edges of the upper end and the lower end of the stress sensor 101.

Thus, a moment M which is applied to the stress sensor 101 at a position which has a distance L1 from the upper end of the stress sensor 101 and has a distance L2 from the lower end of the stress sensor 101, can be expressed as M=L1F1−L2F2. In this case, the clockwise direction is defined as the positive direction of the moment M. The clockwise direction is defined when being viewed in the vehicle left side with respect to the vehicle traveling direction. The vehicle left side corresponds to the facade side of the paper surface of FIG. 11A.

Referring to FIGS. 12A-15, the average load FA and the moment M (defined by M=L1F1−L2F2) applied to the stress sensor 101 will vary responding to the sort of the obstacle, which collides with the bumper 11 of the vehicle, for example. As shown in FIG. 12A, in the case of the obstacle (e.g., power pole) fixed on the ground, the front bumper 11 initially substantially horizontally contacts the obstacle at the beginning (that is, at time t0) of the collision between the obstacle and the vehicle. Thereafter, as shown in FIG. 12B, with the progress of the collision (e.g., at time t1, t1>t0), a larger collision load is exerted to the lower portion of the stress sensor 101 than the upper portion of the stress sensor 101 because the lower end portion of the obstacle is fixed on the ground. Thus, the moment M applied to the stress sensor 101 has a negative value, that is, is in a counter-clockwise direction when being viewed in the vehicle left side with respect to the vehicle traveling direction.

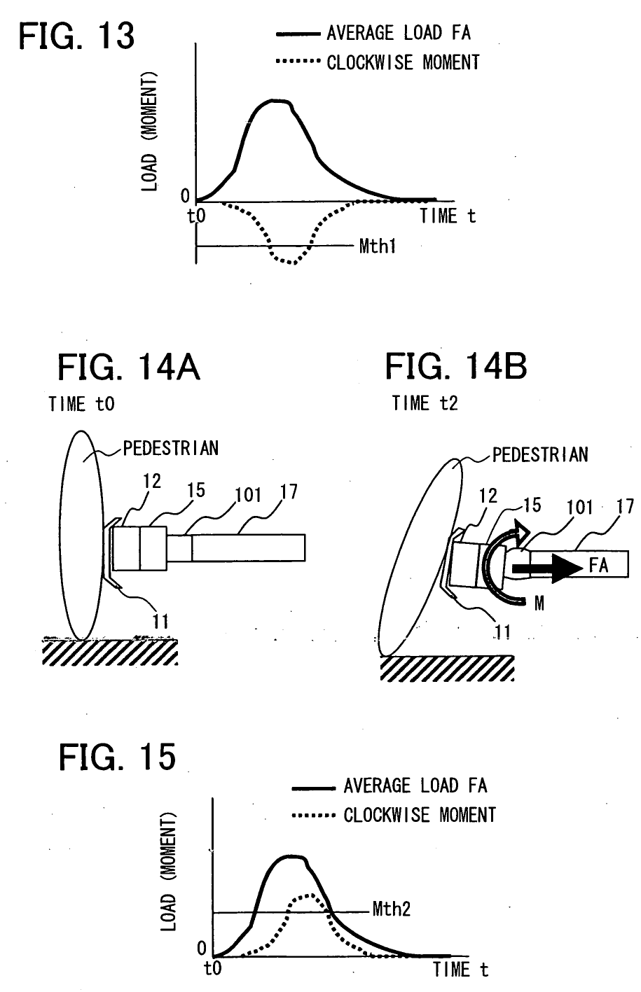

FIG. 13 shows time-series values of the average load FA and the moment M detected by the stress sensor 101 after the collision occurrence in the case of the obstacle fixed on the ground. In this case, the time-series values of the average load FA and the moment M are respectively indicated by a solid line and a broken line. As shown in FIG. 13, the moment M having the counter-clockwise direction (i.e., negative value) is applied to the stress sensor 101 after the collision occurrence.

As shown in FIG. 14A, in the case of the obstacle (e.g., pedestrian) non-fixed on the ground, the front bumper 11 initially substantially horizontally contacts the obstacle at the beginning of the collision (that is, at time t0). That is similar to the case of the obstacle fixed on the ground. Thereafter, with the progress of the collision (e.g., at time t2, t2>t0), the obstacle which is not fixed on the ground falls toward the bonnet of the vehicle so that a larger collision load is exerted to the upper portion of the stress sensor 101 than the lower portion of the stress sensor 101. Therefore, the moment M having the clockwise direction is exerted to the stress sensor 101, as shown in FIG. 14B.

FIG. 15 shows time-series values of the average load FA and the moment M detected by the stress sensor 101 after the collision occurrence in the case of the obstacle non-fixed on the ground. In this case, the time-series values of the average load FA and the moment M are respectively indicated by a solid line and a broken line. As shown in FIG. 15, the moment M having the positive value (i.e., clockwise direction) is applied to the stress sensor 101 after the collision occurrence.

Therefore, in the case of the obstacle fixed on the ground, the moment M having the counter-clockwise direction is applied to the stress sensor 101. On the other hand, in the case of the obstacle (e.g., pedestrian) non-fixed on the ground, the moment M having the clockwise direction is exerted to the stress sensor 101. According to this characteristic, the discrimination unit 18 can sort-discriminate the obstacle.

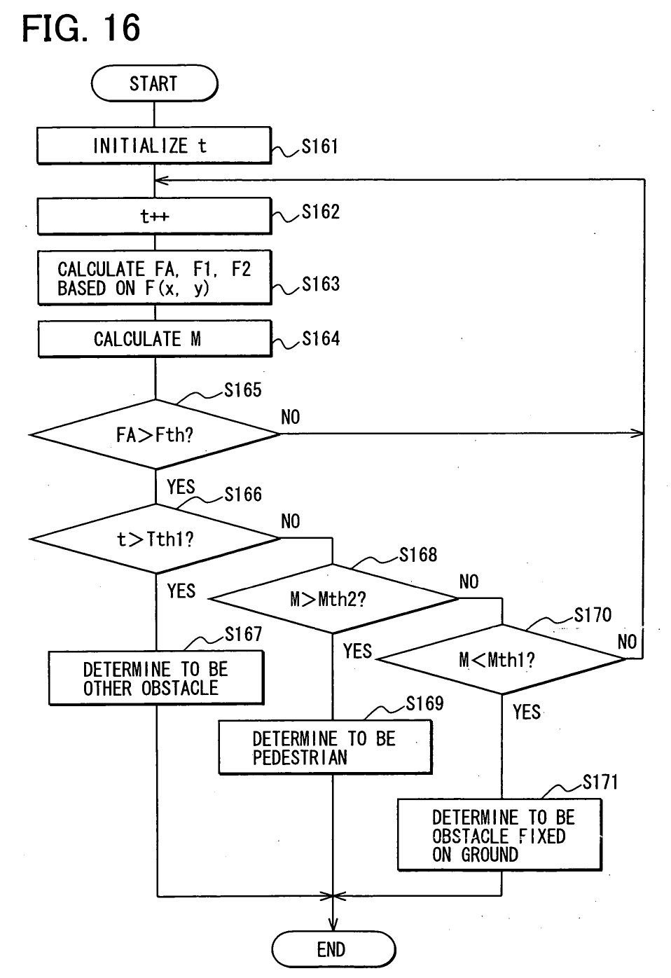

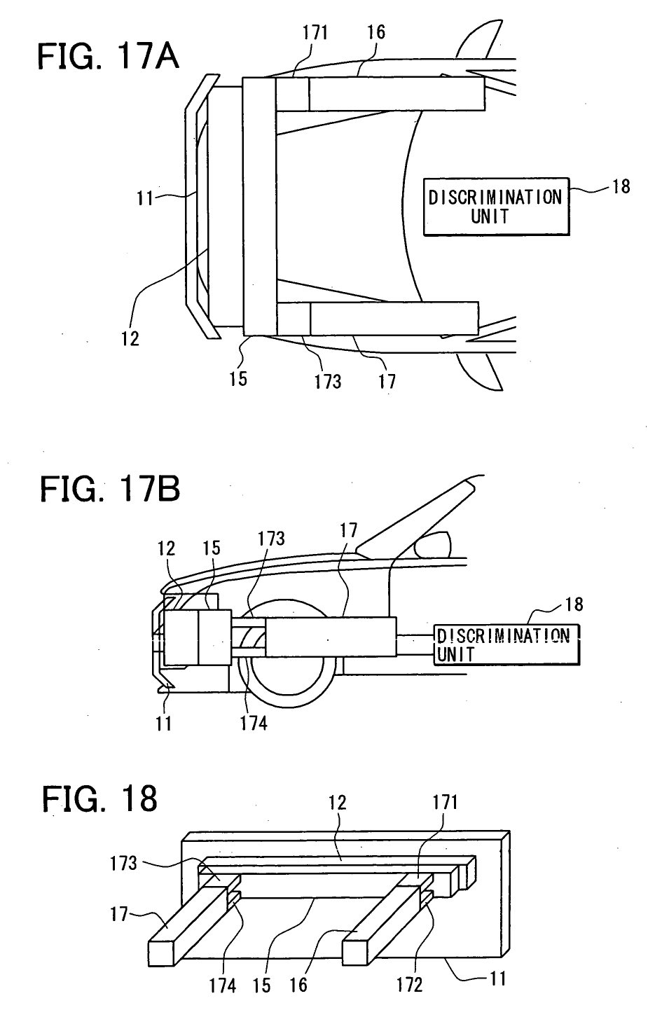

The discrimination operation performed by the discrimination unit 18 is described with reference to FIG. 16. This operation is started when the collision occurs.

At first, at step S161, the time counter t is initialized, that is, t=0. Then, at step S162, “1” is added to the time counter t. At step S163, the average load FA, the load components F1 and F2 which are respectively applied to the edges of the upper end and the lower end of the stress sensor 101 are calculated based on the collision loads F(x, y) (which are exerted at different positions of stress sensor 101) detected by stress sensor 101.

Thereafter, at step 164, the moment M which has the positive direction of the clockwise direction and is expressed as M=L1F1−L2F2 is calculated. Then, at step 165, it is judged whether or not the average load FA is larger than a threshold value Fth. In the case where it is determined that the average load FA is larger than the threshold value Fth, step S166 will be performed. On the other hand, in the case where it is determined that the average load FA is smaller than or equal to the threshold value Fth, the operation will return to step S162 and be performed from step S162 again.

At step S166, it is further judged whether or not the time counter t is larger than the discrimination upper limit time Tth1. In the case where the time counter t is larger than Tth1, it is considered that the human (e.g., pedestrian) and the object fixed on the ground cannot be distinguished by performing the process during the period with the discrimination upper limit time Tth1, and then it is determined at step S167 that the obstacle is an object (e.g., rubbish box, shopping cart and the like which are not fixed on the ground) other than the pedestrian and the object fixed on the ground. Moreover, at step S167, the discrimination result that the obstacle is the object other than the pedestrian and the object fixed on the ground is output.

On the other hand, in the case where it is determined at step S166 that the time counter t is smaller than or equal to the discrimination upper limit time Tth1, step S168 will be performed. At step S168, it is judged whether or not the moment M applied to the stress sensor 101 is larger than a threshold value Mth2. In the case where it is determined that the moment M is larger than the threshold value Mth2 (that is, large clockwise moment M is applied to stress sensor 101, as shown in FIG. 15), step S169 will be performed. At step S169, the discrimination result that the obstacle is the pedestrian is output.

On the contrary, in the case where it is determined that the moment M is smaller than or equal to the threshold value Mth2, step S170 will be performed. At step S170, it is judged whether or not the moment M applied to the stress sensor 101 is smaller than a threshold value Mth1. In the case where it is determined that the moment M is smaller than the threshold value Mth1 (that is, large counter-clockwise moment M is applied to stress sensor 101, as shown in FIG. 13), step S171 will be performed. At step S171, the discrimination result that the obstacle is fixed on the ground is output.

In the case where it is determined that the moment M applied to the stress sensor 101 is larger than or equal to the threshold value Mth1, the operation will return to step S162 and be performed from step S162 again.

In the case where the discrimination result has been output at one of steps S167, S169 and S171, the discrimination operation will be ended.

In this embodiment, the stress sensor 101 can be also replaced by other detection unit which can detect the collision loads F(x, y) exerted at the different positions ranging therein.

According to the third embodiment, the optical fiber sensors 13 and 14 in the first embodiment are replaced by the single stress sensor 101 (referring to FIG. 10). Therefore, the collision obstacle discrimination device of the third embodiment can be constructed of number-reduced members and have the same effect with the first embodiment.

(Fourth Embodiment)

According to a fourth embodiment of the present invention, referring to FIG. 18, the detection unit is constructed of a right-upper tube-typed pressure sensor 171 (first tube-typed pressure sensor), a right-lower tube-typed pressure sensor 172 (second tube-typed pressure sensor), a left-upper tube-typed pressure sensor 173 (third tube-typed pressure sensor) and a left-lower tube-typed pressure sensor 174 (fourth tube-typed pressure sensor), instead of the optical fiber sensors 13 and 14 in the first embodiment.

The right-upper tube-typed pressure sensor 171 and the right-lower tube-typed pressure sensor 172 are arranged between the reinforcement member 15 and the right side member 16, and the right-upper tube-typed pressure sensor 171 is positioned at the vehicle upper side of the right-lower tube-typed pressure sensor 172. The left-upper tube-typed pressure sensor 173 and the left-lower tube-typed pressure sensor 174 are arranged between the reinforcement member 15 and the left side member 17, and the left-upper tube-typed pressure sensor 173 is positioned at the vehicle upper side of the left-lower tube-typed pressure sensor 174.

According to this embodiment, the four collision sensors 171-174 which are arranged between the reinforcement member 15 and the side members 16, 17, are independent of each other in the vehicle up-down direction and the vehicle right-left direction.

In the case where the human (e.g., pedestrian) collides with a right half surface of the front bumpy 11, the outputs of the right-upper tube-typed pressure sensor 171 and the right-lower tube-typed pressure sensor 172 vary as shown in FIG. 7. Similarly, the outputs of the left-upper tube-typed pressure sensor 173 and the left-lower tube-typed pressure sensor 174 have the variation tendency shown in FIG. 7, but have a smaller variation range than the pressure sensors 171 and 172 which are positioned at the vehicle right portion. In this embodiment, the sort of the obstacle and the position at which the obstacle collides with the vehicle can be determined based on the outputs of the pressure sensors 171-174.

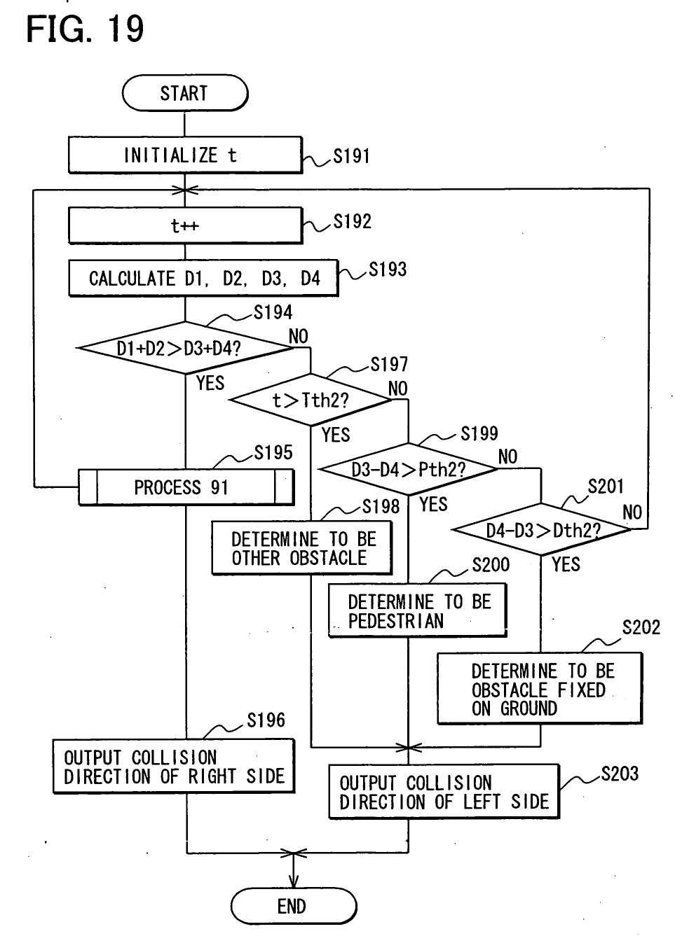

The discrimination operation performed by the discrimination unit 18 according to the second embodiment will described with reference to FIG. 19. This operation is started at the time when the collision occurs.

At first, at step S191, the time counter t is initialized, that is, t is set as “0”. Then, at step S192, “1” is added to the time counter t. At step 193, an output value D1 of the right-upper pressure sensor 171, an output value D2 of the right-lower pressure sensor 172, an output value D3 of the left-upper pressure sensor 173 and an output value D4 of the left-lower pressure sensor 174 are calculated.

Thereafter, at step S194, it is judged whether or not the output sum (D1+D2) of the pressure sensors 171 and 172 of the right side is larger than the output sum (D3+D4) of the pressure sensors 173 and 174 of the left side. In the case where it is determined that the output sum (D1+D2) of the pressure sensors 171 and 172 is larger than the output sum (D3+D4) of the pressure sensors 173 and 174, step S195 will be performed. At step S195, the process 91 shown in FIG, 9 is executed. After step S195 is performed, it is determined at step S196 that the collision direction is the vehicle right portion, and the discrimination result of the collision direction is output. Then, the operation is ended.

In the case where it is determined that the output sum (D1+D2) of the pressure sensors 171 and 172 is smaller than or equal to the output sum (D3+D4) of the pressure sensors 173 and 174, step S197 will be performed. At step S197, it is judged whether or not the time counter t is larger than the discrimination upper limit time Tth2.

In the case where the time counter t is larger than Tth2, it is considered that the human (e.g., pedestrian) and the object fixed on the ground cannot be distinguished by performing the process during the period with the discrimination upper limit time Tth2, and then it is determined at step S198 that the obstacle is the object (e.g., rubbish box, shopping cart and the like which are not fixed on the ground) other than the pedestrian and the object fixed on the ground. Moreover, at step S198, the discrimination result that the obstacle colliding with the left portion of the front bumper 11 is the object other than the pedestrian and the object fixed on the ground, is output.

In the case where it is determined at step S197 that the time counter t is smaller than or equal to the discrimination upper limit time Tth2, step S199 will be performed.

At step S199, it is judged whether or not the difference (D3−D4) between the output value D3 of the left-upper pressure sensor 173 and the output value D4 of the left-lower pressure sensor 174 is larger than the threshold value Pth2. In the case where it is determined that the difference between the output value D3 and the output value D4 is larger than the threshold value Pth2 (that is, difference between load exerted to left-upper pressure sensor 173 and that exerted to left-lower pressure sensor 174 is larger than threshold value Pth2, as shown at time t4 of FIG. 7), step S200 will be performed. At step S200, the discrimination result that the obstacle colliding with the left portion of the front bumper 11 is the pedestrian is output.

On the contrary, in the case where it is determined that the difference between the output value D3 and the output value D4 is smaller than or equal to the threshold value Pth2, step S201 will be performed.

At step S201, it is judged whether or not the difference (D4−D3) between the output value D4 and the output value D3 is larger than the threshold value Dth2. In the case where it is determined that the difference between the output value D4 and the output value D3 is larger than the threshold value Dth2 (that is, difference between load exerted to left-lower pressure sensor 174 and that exerted to left-upper pressure sensor 173 is larger than Dth2, as shown at time t3 of FIG. 5), step S202 will be performed. At step S202, the discrimination result that the obstacle colliding with the left portion of the front bump 11 is fixed on the ground, is output.

On the contrary, in the case where it is determined that the difference between the output value D4 and the output value D3 is smaller than or equal to the threshold value Dth2, the operation will return to step S192 and be performed from step S192 again.

After steps S198, S200 and S202 are performed, the collision direction which is determined to be the vehicle left portion is output at step S203. Thus, the operation is ended.

According to the fourth embodiment, the collision sensors 171-174 are arranged to be independent of each other in the vehicle front-rear direction and the vehicle right-left direction, so that the position of the vehicle where the obstacle collides can be determined in addition to the effect according to the collision obstacle discrimination device described in the first embodiment.

(Fifth Embodiment)

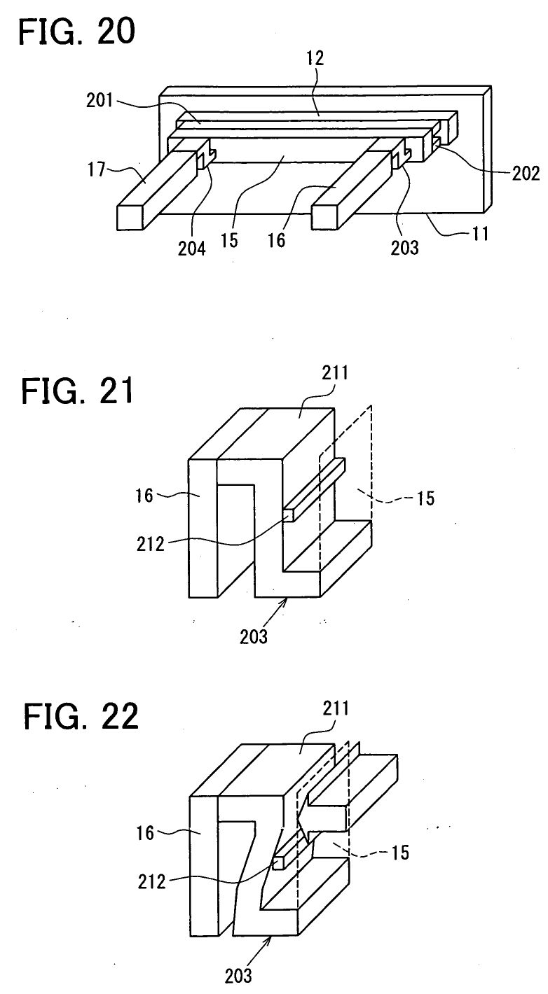

According to a fifth embodiment of the present invention, referring to FIG. 20, the detection unit is constructed of an upper touch sensor 201, a lower touch sensor 202, a right crank-typed sensor 203 and a left crank-typed sensor 204, instead of the optical fiber sensors 13 and 14 described in the first embodiment.

In this case, the upper touch sensor 201 and the lower touch sensor 202 are arranged between the absorber 12 and the reinforcement member 15. The right crank-typed sensor 203 is arranged between the right end portion of the reinforcement member 15 and the right side member 16, and the left crank-typed sensor 204 is arranged between the left end portion of the reinforcement member 15 and the left side member 17.

The touch sensor 201, 202 is constructed of a sensor which has a digital output including “ON” (=1) and “OFF” (=0). In the case where the load is exerted to the front bumper 11 and the absorber 12, the upper touch sensor 201 and the lower touch sensor 202 are compressed between the absorber 12 and the reinforcement member 15 to become switch-on when the value of the load is larger than or equal to a predetermined value. The outputs of the touch sensors 201 and 202 are input to the discrimination unit 18 (not shown).

As shown in FIG. 21, the right crank-typed sensor 203 is constructed of a strain gauge 212 and a crank-shaped metal material member 211, to which the strain gauge 212 is adhered. As shown in FIG. 22, in the case where the load is exerted to the reinforcement member 15, the vertical part (that is, part extending in up-down direction of FIG. 22) of the metal material member 211 which is inserted between the reinforcement member 15 and the right side member 16 is distorted (deformed). The distortion of the vertical part is detected and output by the strain gauge 212. The left crank-typed sensor 204 has a construction same with that of the right crank-typed sensor 203, and the description of the construction of the left crank-typed sensor 204 is omitted here. The outputs of the crank-typed sensors 203 and 204 are input to the discrimination unit 18.

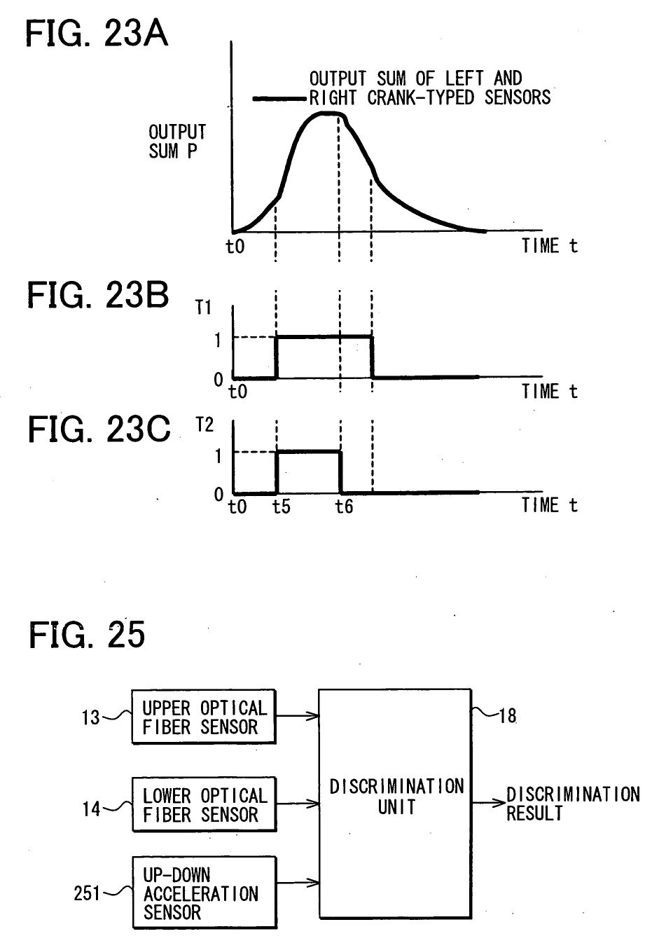

Next, the obstacle sort-discrimination method according to this embodiment will be described with reference to FIGS. 23A, 23B and 23C. FIG. 23A shows a time-series variation of a sum P of an output value P1 of the right crank-typed sensor 203 and an output value P2 of the left crank-typed sensor 204. FIG. 23B shows a time-series variation of the output T1 of the upper touch sensor 201, and FIG. 23C shows a time-series variation of the output T2 of the lower touch sensor 202. The time when the obstacle collides with the front bumper 11 is set as the plot start time t0 of FIGS. 23A, 23B and 23C. FIGS. 23A, 23B and 23C correspond to the case where the obstacle is the pedestrian.

According to this embodiment, the load exerted to the bumper 11 due to the collision of the obstacle is detected by the crank-typed sensors 203 and 204 and used for the sort-discrimination of the obstacle. Thus, the obstacle can be sort-discriminated in view of the mass thereof by using the load exerted to bumper 11 by the obstacle.

The upper touch sensor 201 and the lower touch sensor 202 are provided to distinguish whether or not the obstacle is fixed on the ground. According to this embodiment, the times when the touch sensors 201 and 202 become “ON” due to the load from the obstacle will be used in the sort-discrimination of the obstacle. For example, in the case where the load larger than or equal to the predetermined value is exerted to the touch sensors 201 and 202, the touch sensors 201 and 202 meanwhile become “ON” at the time t5 shown in FIGS. 23B and 23C. Thereafter, because the obstacle is not fixed on the ground to fall toward the bonnet of the vehicle, the load exerted to the lower portion of the front bumper 11 decreases so that the lower touch sensor 202 becomes “OFF” at the time t6 (t6>t5), referring to FIGS. 23B and 23C.

At the time t6, referring to FIG. 23A, it is found that the load from the obstacle detected by the crank-typed sensors 203 and 204 is relatively large, so that it can be determined that the obstacle is not fixed on the ground and has a large weight and a barycenter higher than the upper portion of the front bumper 11. That is, the obstacle is the pedestrian.

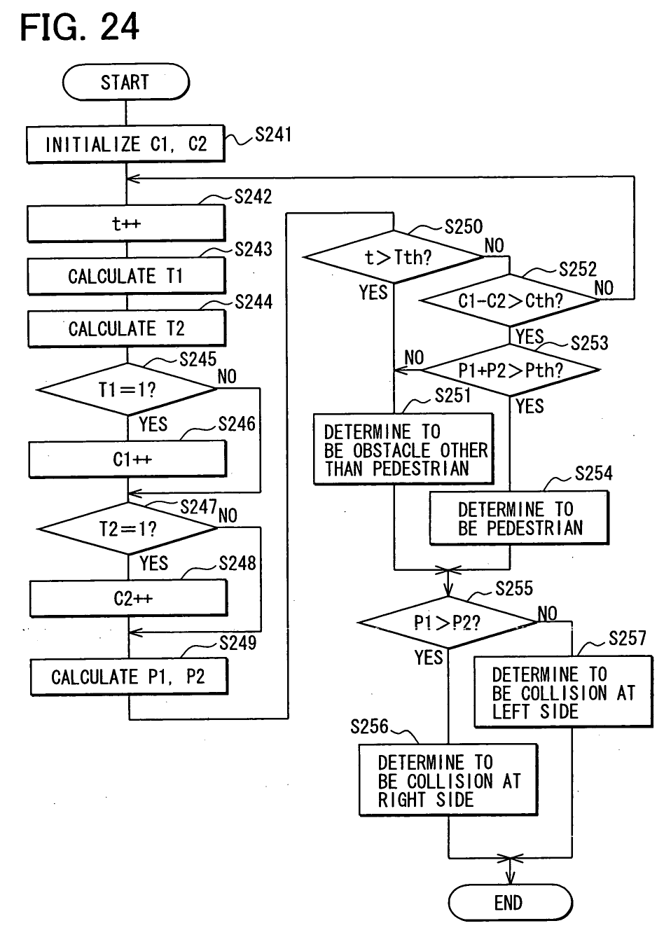

The discrimination operation performed by the discrimination unit 18 according to the fifth embodiment will described with reference to FIG. 24. This operation is started at the time of the collision occurrence.

At first, at step S241, a counter C1, a counter C2 and the time counter t indicating the number of the loop performing are initialized, that is, t=C1=C2=0. Then, at step S242, “1” is added to the time counter t. The digital output value T1 of the upper touch sensor 201 is calculated at step S243, and the digital output value T2 of the lower touch sensor 202 is calculated at step 244.

Then, at step S245, it is judged whether or not the digital output value T1 of the upper touch sensor 201 is “1” (i.e., “ON”). In the case where it is determined at step S245 that the digital output value T1 of the upper touch sensor 201 is “1”, “1” is added to the counter C1 at step S246. Then, step S247 is performed.

On the other hand, in the case where it is determined at step S245 that the digital output value T1 of the upper touch sensor 201 is “0” (i.e., “OFF”), step S247 will be directly performed and step S246 will be omitted.

At step S247, it is judged whether or not the output value T2 of the lower touch sensor 202 is “1” (i.e., “ON”). In the case where it is determined at step S247 that the output value T2 of the lower touch sensor 202 is “1”, “1” is added to the counter C2 at step S248, and then step S249 is performed. On the other hand, in the case where it is determined at step S247 that the output value T2 is “0” (i.e., “OFF”), step S249 will be directly performed without performing step S248. At step S249, the output value P1 of the right crank-typed sensor 203 and the output value P2 of the left crank-typed sensor 204 are calculated. Then, step S250 will be performed.

At step S250, it is judged whether or not the time counter t is larger than a discrimination upper limit time Tth. In the case where the time counter t is larger than Tth, because the obstacle cannot be sort-distinguished by performing the process during the period with the discrimination upper limit time Tth, it is determined that the obstacle is the object other than at least the pedestrian and the discrimination result is output at step S251.

On the other hand, in the case where it is determined at step S250 that the time counter t is smaller than or equal to the discrimination upper limit time Tth, step S252 will be performed. At step S252, it is further judged whether or not the difference (C1−C2) between the counter C1 and the counter C2 is larger than a threshold value Cth. In the case where it is determined that the difference between the counter C1 and the counter C2 is larger than the threshold value Cth, step S253 will be performed.

On the contrary, in the case where the difference between the output value D1 and the output value D2 is smaller than or equal to the threshold value Cth, the operation will return to step S242 and be performed from step S242 again.

At step S253, it is judged whether or not the sum of the output value P1 of the right crank-typed sensor 203 and the output value P2 of the left crank-typed sensor 204 is larger than a threshold value Pth. In the case where it is determined that the sum of the output P1 and the output P2 is larger than the threshold value Pth, step S254 will be performed. At step S254, the discrimination result that the obstacle is the pedestrian is output.

On the other hand, in the case where it is determined at step S253 that the sum of the output value P1 and the output value P2 is smaller than or equal to the threshold value Pth, S251 will be performed. At step S251, it is determined that the obstacle is the object other than at least the pedestrian and the discrimination result is output.

After one of steps S251 and S254 is performed, step S255 will be performed. At step S255, it is judged whether or not the output value P1 of the right crank-typed sensor 203 is larger than the output value P2 of the left crank-typed sensor 204. In the case where it is determined that the output value P1 is larger than the output value P2, step S256 will be performed. At step S256, it is determined that the obstacle collides with the right portion of the bumper 11 and the discrimination result of the collision direction is output.

On the contrary, in the case where it is determined that the output value P1 is smaller than or equal to the output value P2, step S257 will be performed. At step S257, it is determined that the obstacle collides with the left portion of the bumper 11 and the discrimination result of the collision direction is output. After one of the steps S256 and S257 is performed, the operation with reference to FIG. 24 is ended.

According to this embodiment, the two touch sensors 201 and 202 are used so that the manufacture cost of the collision obstacle discrimination device can be reduced, while the collision direction can be determined similar to the fourth embodiment.

(Sixth Embodiment)

A sixth embodiment of the present invention will be described with reference to FIG. 25. In this case, the collision obstacle discrimination device is further provided with a pitching detection unit 251 for detecting a pitching information of the vehicle. For example, the pitching detection unit 251 can be constructed of an up-down acceleration sensor, which detects an up-down-direction acceleration of the vehicle to provide the pitching information.

Referring to FIG. 25, the pitching information of the vehicle detected by the pitching detection unit 251 is input to the discrimination unit 18. Thus, the discrimination unit 18 sort-discriminates the collision obstacle based on the pitching information and the outputs of the upper optical fiber sensor 13 and the lower optical fiber sensor 14, for example.

Next, the reason why the pitching information is introduced into the sort-discrimination of the obstacle will be described. Before the collision between the vehicle and the obstacle, many drivers will apply a brake to the vehicle. Therefore, a front suspension of the vehicle greatly sink (that is, vehicle becomes nose-dive state) when the collision between the obstacle and the vehicle occurs. Thus, in many cases, the front bumper 11 does not horizontally contact with the obstacle at the beginning of the collision.

For example, in the case of the obstacle (e.g., power pole) which is fixed on the ground, when the vehicle becomes the nose-dive state, the upper optical fiber sensor 13 will collide with the power pole earlier than the lower optical fiber sensor 14 because the front surface of the front bumper 11 inclines toward the ground in the nose-dive state. Therefore, the output of the upper optical fiber sensor 13 is larger than that of the lower optical fiber sensor 14. That becomes same with the case where the pedestrian collides with the vehicle as shown in FIGS. 6 and 7. Thus, it is difficult to set the discrimination condition for sort-discriminating the obstacle.

According to this embodiment, the pitching information of the vehicle is used to determine the time when the front surface of the front bumper 11 became vertical to the ground (that is, incline of front surface of front bumper 11 disappears). The operation showing in FIG. 8 is started from this time. Accordingly, in the sort-discrimination of the obstacle, the incline of the front surface of the front bumper 11 can be corrected based on the pitching information, thus simplifying the setting of the sort-discrimination condition of the discrimination unit 18.

(Other Embodiments)

Although the present invention has been fully described in connection with the preferred embodiments thereof with reference to the accompanying drawings, it is to be noted that various changes and modifications will become apparent to those skilled in the art.

For example, the discrimination unit can also determine that the obstacle is the object non-fixed on the ground in the case where the upper detection signal detected by the upper sensor (e.g., upper optical fiber sensor 13) is larger than a predetermined value, in addition to the comparison of the upper detection signal with the lower detection signal detected by the lower sensor (e.g., lower optical fiber sensor 14).

Moreover, the moment applied to the detection unit can be also calculated based on the upper detection signal, the upper position of the upper sensor (13, 171, 173, 201) where the upper detection signal is detected, the lower detection signal and the lower position of the lower sensor (14, 172, 174, 202) where the lower detection signal is detected. In this case, the positive direction of the moment is set as a clockwise direction when being viewed in a vehicle left side with respect to a vehicle traveling direction. The moment and at least one of the upper detection signal and the lower detection signal are used in the sort-discrimination condition of the discrimination unit 18.

Furthermore, the detection unit in the present invention can be also constructed of a strain gauge, a G sensor and the like.

Moreover, the obstacle can be also sort-discriminated based on both the information from the detection unit (i.e., collision sensors) described in the above embodiments and the information from a vehicle-mounted camera or the like. Thus, the sort-discrimination accuracy of the obstacle can be further improved.

In the third embodiment, the collision loads (load components F1 and F2) applied to the stress sensor 101 (vehicle) at the upper position and the lower position are detected by the stress sensor 101, and the moment M is calculated based on the collision loads. The moment M and the collision loads F1, F2 are used as the discrimination condition. However, the moment can be also obtained without based on the collision load. For example, a single sensor capable of detecting both the collision load and the moment can be provided. Then, the obstacle is sort-discriminated according to the detected collision load and moment. Thus, the effect same with the third embodiment can be provided.

In the above-described embodiments, the collision obstacle from the front side of the vehicle is sort-discriminated. However, the collision direction of the obstacle which is sort-discriminated is not limited to the front side of the vehicle. For example, two optical fiber sensors can be inserted between an absorber of the vehicle rear portion and a reinforcement member of the vehicle rear portion, so that the collision obstacle from the rear side of the vehicle can be also sort-iscriminated.

Furthermore, the values of the threshold values (Tth, Tth1, Tth2, Pth, Pth1, Pth2, Dth1, Dth2, Mth1, Mth2 and Cth) which are used in the above-described embodiments can be also not fixed. For example, these threshold values can be also corrected manually or automatically to reduce the influences of the ambient temperature variation, the age deterioration and the like of the sensors such as the G sensor and the strain gauge. Thus, the sort-discrimination accuracy of the obstacle can be further improved.

In the above-described embodiments, the threshold values (Tth, Tth1, Tth2, Pth, Pth1, Pth2, Dth1, Dth2, Mth1, Mth2 and Cth) are respectively used for the branch judgments in the obstacle discrimination process and the like. However, an inference using a Fuzzy Set, a neural network or the like can be also used for the branch judgments, instead of the threshold values.

Such changes and modifications are to be understood as being in the scope of the present invention as defined by the appended claims.

What is claimed is:

1. A collision obstacle discrimination device for a vehicle, comprising:
a detection unit which is arranged between a bumper and side members of the vehicle,
the detection unit detecting collision energy applied to the bumper at at least an upper position and a lower position thereof, to respectively output at least an upper detection signal corresponding to the upper position and a lower detection signal corresponding to the lower position when an obstacle collides with the bumper; and
a discrimination unit which sort-discriminates the obstacle based on the upper detection signal and the lower detection signal.

2. The collision obstacle discrimination device according to claim 1, wherein
the discrimination unit sort-discriminates the obstacle by comparing the upper detection signal with the lower detection signal.

3. The collision obstacle discrimination device according to claim 2, wherein:
the detection unit includes an upper sensor and a lower sensor which is positioned at a vehicle lower side of the upper sensor; and
the upper sensor outputs the upper detection signal and the lower sensor outputs the lower detection signal.

4. The collision obstacle discrimination device according to claim 2, wherein the detection unit is arranged between an absorber of the vehicle and a reinforcement member of the vehicle.

5. The collision obstacle discrimination device according to claim 2, wherein the detection unit is arranged between a reinforcement member of the vehicle and the side members.

6. The collision obstacle discrimination device according to claim 2, wherein
the discrimination unit sort-discriminates the obstacle, by using amplitudes of the upper detection signal and the lower detection signal at a time when a predetermined period has elapsed from an occurrence of the collision.

7. The collision obstacle discrimination device according to claim 2, wherein
the discrimination unit sort-discriminates the obstacle, by using amplitudes of time-series variation amounts of the upper detection signal and the lower detection signal at a time when a predetermined period has elapsed from an occurrence of the collision.

8. The collision obstacle discrimination device according to claim 2, wherein
the discrimination unit determines that the obstacle is an object fixed on a ground in the case where a difference between the lower detection signal and the upper detection signal is larger than a predetermined value, the upper detection signal being smaller than the lower detection signal.

9. The collision obstacle discrimination device according to claim 2, wherein
the discrimination unit determines that the obstacle is an object non-fixed on a ground in the case where a difference between the upper detection signal and the lower detection signal is larger than a predetermined value, the upper detection signal being larger than the lower detection signal.

10. The collision obstacle discrimination device according to claim 2, wherein
the discrimination unit determines that the obstacle is an object non-fixed on a ground in the case where the upper detection signal is larger than a predetermined value, in addition to the comparison of the upper detection signal with the lower detection signal.

11. The collision obstacle discrimination device according to claim 2, further comprising
a pitching detection unit for detecting a pitching information of the vehicle, wherein
the pitching information detected by the pitching detection unit is used in the sort-discrimination of the obstacle by the discrimination unit.

12. The collision obstacle discrimination device according to claim 2, wherein:
a moment applied to the detection unit is calculated based on the upper detection signal, the upper position of the detection unit where the upper detection signal is detected, the lower detection signal and the lower position of the detection unit where the lower detection signal is detected, a positive direction of the moment being set as a clockwise direction when being viewed in a vehicle left side with respect to a vehicle traveling direction; and
the moment and at least one of the upper detection signal and the lower detection signal are used in a sort-discrimination condition of the discrimination unit.

13. The collision obstacle discrimination device according to claim 3, wherein:
a moment applied to the detection unit is calculated based on the upper detection signal, the upper position of the upper sensor where the upper detection signal is detected, the lower detection signal and the lower position of the lower sensor where the lower detection signal is detected, a positive direction of the moment being set as a clockwise direction when being viewed in a vehicle left side with respect to a vehicle traveling direction; and
the moment and at least one of the upper detection signal and the lower detection signal are used in a sort-discrimination condition of the discrimination unit.

14. The collision obstacle discrimination device according to claim 12, wherein
the discrimination unit determines that the obstacle is an object non-fixed on a ground, in the case where at least one of the upper detection signal and the lower detection signal is larger than a first predetermined value and the moment is larger than a second predetermined value.

15. The collision obstacle discrimination device according to claim 12, wherein
the discrimination unit determines that the obstacle is an object fixed on a ground, in the case where at least one of the upper detection signal and the lower detection signal is larger than a first predetermined value and the moment is smaller than a second predetermined value.

16. The collision obstacle discrimination device according to claim 1, wherein:
the detection unit further detects a moment applied to the bumper when the obstacle collides with the bumper; and
the discrimination unit sort-discriminates the obstacle by comparing the collision energy detected by the detection unit with a first predetermined value, and comparing the moment with a second predetermined value.

17. The collision obstacle discrimination device according to claim 16, wherein
the discrimination unit determines that the obstacle is an object non-fixed on a ground, in the case where the collision energy is larger than the first predetermined value and the moment is larger than the second predetermined value.

18. The collision obstacle discrimination device according to claim 16, wherein
the discrimination unit determines that the obstacle is an object fixed on a ground, in the case where the collision energy is larger than the first predetermined value and the moment is smaller than the second predetermined value.

19. The collision obstacle discrimination device according to claim 1, wherein:
the detection unit includes a first tube-typed pressure sensor, a second tube-typed pressure sensor, a third tube-typed pressure sensor and a fourth tube-typed pressure sensor;
the second tube-typed pressure sensor and the first tube-typed pressure sensor which is disposed at the vehicle upper side of the second tube-typed pressure sensor are arranged between the reinforcement member and the right side member positioned at a vehicle right portion; and
the fourth tube-typed pressure sensor and the third tube-typed pressure sensor which is disposed at the vehicle upper side of the fourth tube-typed pressure sensor are arranged between the reinforcement member and the left side member positioned at a vehicle left portion.

20. The collision obstacle discrimination device according to claim 1, wherein:
the detection unit includes an upper touch sensor, a lower touch sensor, a right crank-typed sensor and a left crank-typed sensor;
the lower touch sensor and the upper touch sensor which is disposed at the vehicle upper side of the lower touch sensor are arranged between an absorber and a reinforcement member of the vehicle; and
the right crank-typed sensor is arranged between a right end portion of the reinforcement member and the right side member positioned at a vehicle right portion, and the left crank-typed sensor is arranged between a left end portion of the reinforcement member and the left side member positioned at a vehicle left portion.
